(19) United States
(12) Patent Application Publication
(10) Pub. No.: US 2010/0062342 A1
(43) Pub. Date: Mar. 11, 2010

(54) POLYMER MEMBRANE UTILIZED AS A SEPARATOR IN RECHARGEABLE ZINC CELLS

(76) Inventor: Lin-Feng Li, Croton-on-Hudson, NY (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/207,354

(22) Filed: Sep. 9, 2008

(51) Int. Cl. H01M 2/16

(52) U.S. Cl. 429/254; 429/247

(57) ABSTRACT

A separator for zinc electrode-based cells that is effective in preventing dendrite growth in a zinc rechargeable cell is prepared as A standalone membrane, or as a composite membrane by impregnating the membrane into a nonwoven fabric. Interpenetrating polymer networks are employed by combining two different polymers. The two polymers penetrate each other on a molecular scale so that mechanical strength, water content and conductivity of the membranes can be effectively optimized. Since the water content of membrane can be optimized by introducing high water content polymers other than polyvinyl alcohol, wherein the diffusion of water from the separator membrane when the membrane contacts alkaline electrolyte solution can be largely reduced. Such membranes demonstrate excellent dendrite blocking capability in a practical zinc rechargeable cell.

### CROSS-REFERENCE TO RELATED APPLICATIONS

This application relates to a non-provisional U.S. patent application entitled “Rechargeable Zinc Cell with Longitudinally-folded Separator” by inventors Lin-Feng Li, Fuyuan Ma, and Zhenghao Wang and to a non-provisional U.S. patent application entitled “Non-Toxic Alkaline Electrolyte with Additives for Rechargeable Zinc Cells” by inventor Lin-Feng Li, both filed concurrently, which applications are incorporated herein in their entirety by reference.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to battery separators for alkaline cells, and more specifically to a separator for zinc electrode-based cells comprising interpenetrating entangled polymer networks of two different polymers.

2. Description of Related Art

Increasingly strict environmental regulations, surging oil prices, the proliferation of the Internet and electronic devices have given rise to new growing markets such as hybrid vehicles, electric vehicles, renewable energy storage systems, UPS systems for data centers, and telecommunications devices to name a few. With increasing attention on Hybrid Electric Vehicles (HEVs), Plug-in Hybrid Electric Vehicles (PHEVs) and Electric Vehicles (EVs), there is a genuine demand for high performance batteries that can meet future challenges, including high power delivery (power density), high energy storage capability (energy density), more reliability and safety, longer life, low cost, and benign in their effect on the environment.

Various battery chemistries have been explored as higher energy density alternatives for conventional lead acid and nickel cadmium batteries. Since, these old incumbent battery technologies cannot keep up with increasing energy requirements for new applications, and they pose substantial environmental problems.

Zinc has long been recognized as an ideal electrode material, due to its high specific capacity (813 Ah/kg), low electrochemical overpotential (resulting in higher cell voltage), high coulombic efficiency, reversible electrochemical behavior, high rate capability, high abundance in the Earth's crust with consequent low material cost, and environmental friendliness. Accordingly, rechargeable zinc electrode-based cells, such as, for exemplary purposes only, nickel/zinc, silver/zinc, manganese dioxide (MnO₂)/zinc and zinc/air cells, are of significant interest. Compared to nickel cadmium cells, nickel/zinc cells have an open circuit voltage over 1.72 V vs. 1.4 V for nickel/cadmium cells. Further, huge environmental issues have been found in recent years for both manufacturing and disposing toxic nickel/cadmium cells. Therefore, there is a strong market need for developing high power, long cycle life and environmentally-friendly rechargeable batteries utilizing zinc as the anode material.

Despite these advantages, conventional rechargeable zinc cells suffer short cycle life. This problem is now believed to be caused by three major effects, including shape change of the zinc electrode, dendrite growth leading to internal shorting, and shedding of zinc electrode material during cycling, resulting in loss of contact of the shed material with the electrode.

Although zinc based cells such as nickel/zinc cells, silver/zinc cells, and manganese oxide-zinc cells, along with zinc/active carbon supercapacitors have demonstrated high power and/or high energy densities, low cost, and freedom from the risk of environmental pollution upon disposal, these cells still retain serious drawbacks, including zinc dendrite growth during charging which could cause a short-circuit inside the cells. Many efforts have been made to solve this problem by using polymer membranes. Cross-linked polyvinyl alcohol (PVA) or non-cross-linked PVA have employed for this purpose (See U.S. Pat. Nos. 4,154,912 to Philipp et al.; 4,272,470 to Hsu et al.; 6,033,803 to Senyarich et al; 5,496,649 to Mallory et al.; 5,290,645 to Tanaka et al.; L. C. Hsu and D. W. Sheibley, J. Electrochem. Soc., page 251, February, 1982; and D. W. Sheibley, M. A. Manzo and O. Gonzalez-Sanabria, J. Electrochem. Soc., page 255, February 1983). However, the pore structure of PVA membrane is developed after water diffuses out of the membrane once the membrane is dipped in the electrolyte solution. This pore structure can allow transfer of dendrites. Other polymer membranes were also investigated as separators for metal/air fuel cells, such as, for example, polybenzimidazole (U.S. Pat. No. 5,688,613 to Li et al.) and highly sulfonated polymeric membrane (U.S. Pat. No. 5,468,574 to Ehrenberg et al.). Due to the hydrophobicity of those membranes, they reject water and do not retain water within membrane structure. Hence, they cannot be utilized for high performance battery separators.

Very recently, one patent (WO2000/51198 to Chen et al.) discloses a method to prepare solid gel membranes. The method provides polymer-based solid gel membranes that contain ionic species within their solution phase promoting high conductivity to anions or cations. However, the method requires a strong base, such as potassium hydroxide, as catalyst for polymerization and the polymerization rate is too fast to be controlled in large scale membrane production. Meanwhile, the presence of the base could damage some monomers that will decompose at high pH values. Further, some water-soluble polymers cannot be mixed in basic solutions, which limits the range of polymers that can be utilized with this method, especially eliminating those water-soluble polymers that can improve the mechanical strength of the membranes.

Prior efforts have emphasized the functions of single polymer membranes of polyvinyl alcohol (PVA) with some additives. However, PVA does not have high inherent water content and conductivity. Accordingly, the diffusion of water from a PVA membrane results in the membrane drying out and generating an open pore structure within the membrane. Unfortunately, dendrites can easily grow through this open pore structure. Even cross-linked PVA membranes can be penetrated by dendrites in a short time.

In previous attempts to construct a membrane for zinc cells (Philipp et al., U.S. Pat. No. 4,154,912), cross-linked PVA was employed as the separator in zinc rechargeable cells. Specifically, chemical cross-linking agents such as dialdehyde were utilized to cross link the diol group in the PVA polymer chain. However, PVA alone does not provide good water content within the membrane and the ionic conductivity of the membrane is thus relatively low. An additional problem is the cross-linking density of the PVA membrane can change the properties of the membrane dramatically. If the degree of cross linking is too high, the membrane will be very brittle. Otherwise, the membrane will be too weak when cross-linking density is low. A third problem associated with previous membranes is very limited process time before gelling of the polymer occurs, when the polymer contains a mixture of cross linking agents. Moreover, cross-linking has demonstrated limited success in extending the cycle life of Ni—Zn cells.

A lot of effort has been applied to developing polymer based membranes as battery separators due to their good processing properties, stability and mechanical properties. Water-soluble polymers, especially polyvinyl alcohol (PVA), have demonstrated good performance as battery separators. Some patents and journal articles reported the application of cross-linked PVA membranes for the separator. Nonetheless, as mentioned hereinabove, lower water content of cross-linked PVA can produce an open pore structure in the membrane after it placed in contact with alkaline electrolyte solution. Further, cross-linked PVA has low ionic conductivity resulting in low performance in the rechargeable cells.

Therefore, it is readily apparent that there is a need for a new zinc cell membrane that can reduce zinc electrode shape change and minimize the growth of zinc dendrites, while still maintaining the high power capability and environmental friendliness of the zinc-based rechargeable cells. An ideal separator could not only block dendrites growth from anode side to cathode side, but also substantially reduce electrode shape change, thereby extending the cycle life of zinc based rechargeable cells.

### BRIEF SUMMARY OF THE INVENTION

Briefly described, in a preferred embodiment, the present invention overcomes the above-mentioned disadvantages and meets the recognized need for such a device by providing a separator that is effective in preventing dendrite growth in a zinc rechargeable cell. The separator is prepared as a standalone membrane, or a composite membrane by impregnating the membrane into a nonwoven fabric or microporous substrate. Further, the present method can be utilized to manufacture large quantity separators for rechargeable zinc cells. The zinc electrodes may be manufactured by combining a powdered mixture of the desired materials, typically zinc metal and zinc oxide, and a binder that is rolled onto a suitable current collector, such as, for exemplary purposes only, a copper screen.

In the preferred embodiment, interpenetrating polymer networks are employed by combining two different polymers. The two polymers penetrate each other on a molecular scale so that mechanical strength, water content and conductivity of the membranes can be effectively optimized. Since the water content of membrane can be enhanced by introducing polymers other than PVA that have high water content, the diffusion of water from the membrane when membrane is contacted by alkaline electrolyte solution can be largely reduced. High water content is generally associated with high water permeability, which is one of the desirable characteristics of the ideal separator for a rechargeable zinc battery. Further, such membranes also demonstrate excellent dendrite blocking capability in a practical zinc rechargeable cell.

In the preferred embodiment, by utilizing an interpenetrating polymer network, various factors can be adjusted to optimize the membrane water content, ionic conductivity, cross-linking density, mechanical strength etc. Polymers with different properties can penetrate and entangle with each other to form a matrix through hydrogen bonding, thereby generating an interpenetrating network that exhibits the desired properties. The preferred embodiment separator effectively resists erosion by an alkaline electrolyte and/or other additives, and exhibits good mechanical and chemical stability.

According to its major aspects and broadly stated, the present invention in its preferred form is a separator membrane comprising a first polymer having a degree of hydrogenation between approximately 50%-approximately 100%, and more particularly between approximately 80-approximately 98%, and having the structure (—CR₂—CR(—OH)—)ₙ, wherein R═H and/or F, and wherein n is between approximately 10-approximately 10 million, more particularly n=5000−2 million; a second polymer having the structure (—CR₁R₂—CR₃X—)ₙ₁, where in R₁, R₂, and R₃═H and/or F and/or CH₃, and wherein n1 is between approximately 10-approximately 10 million, and wherein X═—COOH, —SO₄H, —SO₃H, —PO₃H₂ and/or -Φ-SO₃H, the corresponding cationic salts of —COOH, —SO₄H, —SO₃H, —PO₃H₂ and/or -Φ-SO₃H; and a substrate selected from the group consisting of non-woven substrates and microporous substrates.

The first and second polymers form an interlocking network of cross-linked polymer structure, wherein hydrogen bonding occurs between —OH . . . O—, and wherein said interlocking network reduces swelling of the polymer membrane.

The first polymer is preferably polyvinyl alcohol (PVA) and/or fluoro-substituted PVA and the second polymer is preferably a water-soluble, KOH electrolyte-insoluble, film-forming. The separator may further include nanosize inorganic particles insoluble in KOH electrolyte to enhance the compressive strength of the membrane.

The separator is formed by mixing the first polymer with the second water soluable polymer, wherein an interpenetrating network is created through hydrogen bond interaction of two polymers. The mixture is subsequently applied to a substrate of non-woven and/or microporous material.

In a further preferred embodiment, the separator for zinc electrode-based cells comprises an interpenetrating polymer network of polyvinyl alcohol with another polymer of polyacrylic acid, polymethylacrylic acid and/or polysodium methacrylate.

More specifically, the present invention is a separator membrane, having a cross-linked structure, made from a mixture of a first polymer comprising (—CR₂—CR(—OH)—)ₙ, wherein R═H, F, such as, for exemplary purposes only, polyvinyl alcohol (PVA) or fluoro-substituted PVA, n=approximately 10-approximately 10 million, with a degree of hydrogenation of approximately 50%-approximately 100%, preferably between n=approximately 5000-approximately 2 million with a degree of hydrogenation of approximately 80-approximately 98%, and a second polymer comprising (—CR₁R₂—CR₃X—)ₙ, wherein R₁, R₂, R₃═H, F, CH₃ and n=approximately 10-approximately 10 million, and X═—COOH, —SO₄H, —SO₃H, —PO₃H₂, -Φ-SO₃H or their corresponding cationic salts of K, Na, Li, Cs, Rb, Ca, Mg, Be, Zn.

The separator membrane is prepared from water-soluble polymers and porous substrates comprising nonwoven fiber sheets and/or microporous separators. The water-soluble polymers are coated on a release liner to produce a standalone separators, or may be impregnated into a porous substrate to form a composite membrane.

A further set of water soluble/KOH electrolyte insoluble polymers, such as, for exemplary purposes only, methylcellulose, ethylcellulose, hydroxyethylmethylcellulose, hydroxypropylmethylcellulose, hydroxybutylmethylcellulose, polyvinylpyrrolidone (PVP), are selectively added to the above-described mixture to facilitate film forming properties of the mixture.

Further, nanosized inorganic particles insoluble in KOH electrolyte, such as, ZrO₂, TiO₂, KTiO₃, LiTiO₃, Al₂O₃, CaO, BaSO₄, CaCO₃ and BaCO₃ can be added to the polymer network to form a nanocomposite membrane to enhance the compressive strength of the membrane.

Accordingly, a feature and advantage of the present invention is its high water absorbance.

Another feature and advantage of the present invention is its high ionic conductivity (>0.1 S/cm) in 30% by weight KOH electrolyte.

Still another feature and advantage of the present invention is its excellent mechanical strength.

Yet another feature and advantage of the present invention is its stability in electrolyte (in 10-55% KOH).

Yet still another feature and advantage of the present invention is ability to transport water and ions.

A further feature and advantage of the present invention is its dense structure with no physical pores

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 depicts a cross-linked polyvinyl alcohol component of an alkaline battery separator according to a prior art embodiment; and

FIG. 2 depicts a schematic illustration of an interpenetrating polymer network of polyvinyl alcohol and a water soluble polymer according to a preferred embodiment, as formed separately or within a non-woven matrix.

### DETAILED DESCRIPTION OF THE PREFERRED AND SELECTED ALTERNATE EMBODIMENTS OF THE INVENTION

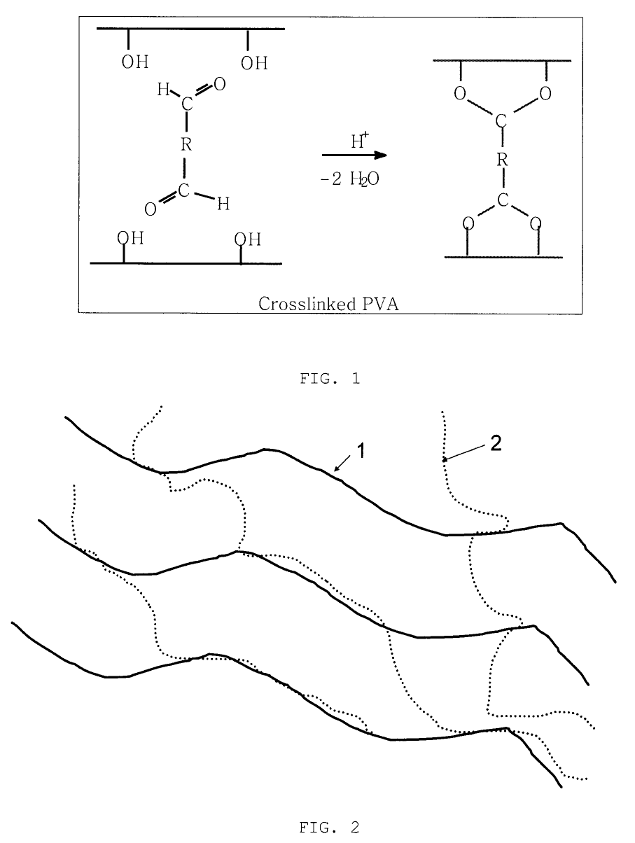

In describing the preferred and selected alternate embodiments of the present invention, as illustrated in FIGS. 1-2, specific terminology is employed for the sake of clarity. The invention, however, is not intended to be limited to the specific terminology so selected, and it is to be understood that each specific element includes all technical equivalents that operate in a similar manner to accomplish similar functions.

Zinc cells have excellent characteristics, while short cell cycle life prevents their widespread application as secondary batteries. Previously, as shown in FIG. 1 illustrating cross-linked PVA utilized in prior art to make membrane separators for rechargeable zinc cells, it had been found that diffusion of water in a membrane during processing and the subsequent drying out of the membrane will result in an open pore structure in the membrane that permits dendrites to pass through the separator. Retention of water within a membrane while providing a dense structure that reduces or prevents dendrite penetration is desired in fabrication of high quality separator membranes.

The preferred embodiment provides achievement of a long life membrane that is easily manufacturable. By utilizing hydrogen bonding, an interpenetrated polymer network is formed, which effectively prevents dendrite growth in a zinc cell during charging process.

Referring now to FIG. 2, the present invention in a preferred embodiment is a separator membrane comprising the following polymers disposed within a non-woven or microporous substrate:

### Polymer 1

(—CR₂—CR(—OH)—)ₙ, wherein R═H, F, and wherein polymer 1 comprises for exemplary purposes only, polyvinyl alcohol (PVA) or fluoro-substituted PVA, wherein n is between approximately 10 and approximately 10 million, having a degree of hydrogenation of between approximately 50% and approximately 100%. It has been found that a preferred range comprises between n=approximately 5000 to approximately 2 million with a degree of hydrogenation of between approximately 80 and approximately 98%.

### Polymer 2

(—CR₁R₂—CR₃X—), where R₁, R₂, R₃═H, F, CH₃, wherein n=between approximately 10 and approximately 10 million, and wherein X═—COOH, —SO₄H, —SO₃H, —PO₃H₂, -Φ-SO₃H or their corresponding salts of cations K, Na, Li, Cs, Rb, Ca, Mg, Be, Zn.

Turning now more particularly to FIG. 2, polymers 1 and 2 are mixed in a range of from approximately 0.001 to approximately 10000, and preferably between approximately 10 to approximately 0.1 weight ratio. Hydrogen bonding takes place between —OH . . . O—, thereby forming an interlocking polymer network with cross-linked polymer structure, wherein the network prevents excess swelling of the polymer membrane and facilitates blocking of dendrite growth in a zinc electrode-based cell, while maintaining good ionic conductivity through the separator.

In the preferred embodiment, the separator is prepared from water-soluble polymers and/or porous substrates, including, without limitation, nonwoven fiber sheets, such as, for exemplary purposes only, Freudenburg FS2225, or from microporous separators, such as, for exemplary purposes only CELGARD 3401. Alternately, water-soluble polymers is coated on a release liner to produce a standalone separator.

Once prepared, the separator membrane is utilized to encase a zinc electrode, thereby preventing dendrite growth and shape change.

In an alternate embodiment of the present invention, another set of polymers can be added to the above-described mixture to facilitate film forming properties of the mixture. This set of polymers is soluble in water for solvent-free processing; however, they are insoluble in the KOH electrolyte that is normally utilized in zinc electrochemical cells. This set of polymers includes, but is not limited to, methylcellulose, ethylcellulose, hydroxyethylmethylcellulose, hydroxypropylmethylcellulose, hydroxybutylmethylcellulose, polyvinylpyrrolidone (PVP).

In yet another alternate embodiment, nanosized inorganic particles insoluble in KOH electrolyte can be introduced into the polymer network to form a nanocomposite membrane. The preferred inorganic compounds include, without limitation, ZrO₂, TiO₂, KTiO₃, LiTiO₃, Al₂O₃, CaO, BaSO₄, CaCO₃ and BaCO₃.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A separator membrane for electrochemical cells, said membrane comprising:
a first polymer, wherein said first polymer comprises a polymer of the structure (—CR₂—CR(—OH)—)ₙ, wherein R is selected from the group consisting of H, F, and combinations thereof, and wherein n is between approximately 10-approximately 10 million;
a second polymer, wherein said second polymer comprises a polymer of the structure (—CR₁R₂—CR₃X—)ₙ₁, where in R₁, R₂, and R₃ are selected from the group consisting of H, F, CH₃, and combinations thereof, and wherein n1 is between approximately 10-approximately 10 million, and wherein X is selected from the group consisting of —COOH, —SO₄H, —SO₃H, —PO₃H₂, -Φ-SO₃H, the corresponding cationic salts of —COOH, —SO₄H, —SO₃H, —PO₃H₂, -Φ-SO₃H, and combinations thereof; and
a substrate selected from the group consisting of non-woven substrates and microporous substrates.

2. The separator membrane of claim 1, wherein said cationic salts are selected from the group consisting of K, Na, Li, Cs, Rb, Ca, Mg, Be, Zn, and combinations thereof.

3. The separator membrane of claim 1, wherein said first polymer comprises polyvinyl alcohol (PVA).

4. The separator membrane of claim 1, wherein said first polymer comprises fluoro-substituted PVA.

5. The separator membrane of claim 1, wherein said first polymer comprises a degree of hydrogenation between approximately 50%-approximately 100%.

6. The separator membrane of claim 1, wherein said first polymer comprises a degree of hydrogenation of between approximately 80-approximately 98%.

7. The separator membrane of claim 1, wherein said first polymer comprises n between approximately 5000-approximately 2 million.

8. The separator membrane of claim 1, wherein hydrogen bonding occurs between —OH . . . O—.

9. The separator membrane of claim 8, wherein said first and second polymers form an interlocking network of cross-linked polymer structure.

10. The separator membrane of claim 9, wherein said interlocking network reduces swelling of the polymer membrane.

11. The separator membrane of claim 1, a water-soluble, KOH electrolyte-insoluble, film-forming polymer selected from the group consisting of methylcellulose, ethylcellulose, hydroxyethylmethylcellulose, hydroxypropylmethylcellulose, hydroxybutylmethylcellulose, polyvinylpyrrolidone (PVP), and combinations thereof.

12. The separator membrane of claim 1, nanosize inorganic particles insoluble in KOH electrolyte.

13. The separator membrane of claim 12, wherein said nanosize inorganic particles are selected from the group consisting of ZrO₂, TiO₂, KTiO₃, LiTiO₃, Al₂O₃, CaO, BaSO₄, CaCO₃, BaCO₃, and combinations thereof.

14. A method of making a separator for electrochemical cells, said method comprising the step of:
mixing a first polymer comprising the structure (—CR₂—CR(—OH)—)ₙ, wherein R is selected from the group consisting of H, F, and combinations thereof, and wherein n is between approximately 10-approximately 10 million with a second polymer comprising the structure (—CR₁R₂—CR₃X—)ₙ₁, where in R₁, R₂, and R₃ are selected from the group consisting of H, F, CH₃, and combinations thereof, and wherein n1 is between approximately 10-approximately 10 million, and wherein X is selected from the group consisting of —COOH, —SO₄H, —SO₃H, —PO₃H₂, -Φ-SO₃H, the corresponding cationic salts of —COOH, —SO₄H, —SO₃H, —PO₃H₂, -Φ-SO₃H, and combinations thereof.

15. The method of claim 14, further comprising the steps of:
forming water solution of polyvinyl alcohol;
forming a solution of water soluble polymer; and
forming an interpenetrating network of said water solution of polyvinyl alcohol and said solution of water soluble polymer.

16. The method of claim 14, further comprising the step of:
applying said mixture to a substrate selected from the group consisting of non-woven substrate and microporous substrates.

17. A separator for zinc electrode-based cells, said separator comprising interpenetrating polymer network of cross-linked polyvinyl alcohol and a second polymer selected from the group consisting of polyacrylic acid, polymethylacrylic acid, polysodium methacrylate, and combinations thereof.

18. The separator of claim 17, wherein said polyvinyl alcohol comprises a degree of hydrogenation between approximately 50%-approximately 100%.

19. The separator of claim 18, wherein said second polymer comprises a cationic salt selected from the group consisting of K, Na, Li, Cs, Rb, Ca, Mg, Be, Zn, and combinations thereof.

20. The separator of claim 17, wherein said polyvinyl alcohol is fluoro-substituted.
